(19) United States
(12) Patent Application Publication
(10) Pub. No.: US 2013/0172001 A1
(43) Pub. Date: Jul. 4, 2013

(54) METHOD FOR INTER-CELL INTERFERENCE COORDINATION IN A CELLULAR COMMUNICATION NETWORK, NETWORK ELEMENT OF A CELLULAR COMMUNICATION NETWORK, AND CELLULAR COMMUNICATION NETWORK

(71) Applicants: Christian Georg Gerlach, Ditzingen (DE); Oliver Stanze, Stuttgart (DE); Bozo Cesar, Stuttgart (DE)

(72) Inventors: Christian Georg Gerlach, Ditzingen (DE); Oliver Stanze, Stuttgart (DE); Bozo Cesar, Stuttgart (DE)

(73) Assignee: ALCATEL LUCENT, Paris (FR)

(21) Appl. No.: 13/822,382

(22) PCT Filed: Aug. 15, 2011
(86) PCT No.: PCT/EP11/64013

§ 371 Date: Mar. 12, 2013

(30) Foreign Application Priority Data
Sep. 14, 2010 (EP) 10290488.5

(51) Int. Cl. H04W 52/24

(52) U.S. Cl. CPC H04W 52/244
USPC 455/450

(57) ABSTRACT

A Method for inter-cell interference coordination in a cellular communication network (11) comprising multiple macro base stations (15) controlling at least one of multiple macro cells (13) of the cellular network (11) and at least one pico base station (21) controlling at least one pico cell (19) of the cellular network (11), said pico cell (19) being located at least partially within at least one macro cell (13) comprises—assigning (57) a first portion (B₁) of radio transmission resources (53) of the cellular network (11) and a second portion (B₂) of said transmission resources (53) to each of said multiple macro base stations (15) for transmitting a radio signal using the first portion (B₁) and the second portion (B₂) of said transmission resources (53) and—limiting a maximum transmission power of the radio signal to be transmitted using the second portion (B₂) to a transmit power limit (P_{red}) less than a maximum transmit power (PE) of the signal to be transmitted using the first portion (B₁). In order to improve an overall throughput of the cellular network (11) and/or the spectral efficiency of transmission resources (53) of the cellular network (11), the method further comprises—assigning (59) the second portion (B₂) of said transmission resources (53) to the pico base station (21) for transmitting the radio signal using the second portion (B2) of said transmission resources.

### FIELD OF THE INVENTION

The present invention refers to a method for inter-cell interference coordination (ICIC) in an cellular communication network comprising multiple macro base stations controlling a macro cell of the cellular network and at least one pico base station (also referred to as low power base station) controlling a pico cell (also referred to as low power cell) of the cellular network, said pico cell being located at least partially within at least one macro cell. Furthermore, the present invention refers to a network element of such a cellular communication network. Moreover, the present invention refers to a cellular communication network comprising multiple base stations controlling a macro cell of the cellular network and at least one pico base station controlling a pico cell of the cellular network, said pico cell being located at least partially within at least one macro cell.

### BACKGROUND

Inter-cell interference coordination (ICIC) is known in the art. In particular, a base station (a so-called eNodeB) of the long term evolution (LTE) cellular radio access network and its successor LTE advanced may coordinate the allocation of radio transmission resources with neighbouring base stations in order to reduce inter-cell interference and to improve an overall spectral efficiency and/or an overall throughput of the radio access network.

A known approach of inter-cell interference coordination is fractional frequency reuse. According to fractional frequency reuse, a base station of a macro cell uses a first portion of radio transmission resources for transmitting a radio signal, a transmission power of which can reach a maximum transmit power. By using the first portion of radio transmission resources the base station can reach terminals of the cellular communication networks located at an edge of the cell controlled by the base station. The base station uses another portion of the transmission resources with a limited transmission power in order to reduce inter-cell interference with neighbouring macro cells. A base station of the neighbouring macro cell may use the further portion of the transmission resources for communicating with a terminal located at a cell edge of said neighbouring macro cell. Therefore, the base station may use all portions of the transmission resources for terminals located in an inner region of the cell and use only a part of the transmission resources for terminals located in a cell edge region of the cell.

The known approaches for inter-cell interference coordination allow to reduce the interference of neighbouring macro cells. However, the known approaches of inter-cell interference coordination do not allow for control the interference between a macro cell and a pico cell located within the macro cell.

### SUMMARY

The object of the present invention is to provide a method, a network element, and a cellular communication network that improve a throughput of cells of a cellular communication network and/or the spectral efficiency of transmission resources of the cellular network.

As a first solution of this object, a method for inter-cell interference coordination in a cellular communication network is suggested, the network comprising multiple macro base stations controlling at least one of multiple macro cells of the cellular network and at least one pico base station controlling at least one pico cell of the cellular network, said pico cell being located at least partially within at least one macro cell, said method comprising: assigning a first portion of radio transmission resources of the cellular network and a second portion of said transmission resources to each of said multiple macro base stations for transmitting a radio signal using the first portion and the second portion of said transmission resources and limiting a maximum transmission power of the radio signal to be transmitted using the second portion to a transmit power limit, the transmit power limit being less than a maximum transmit power of the signal to be transmitted using the first portion, wherein the method further comprises assigning the second portion of said transmission resources to the pico base station for transmitting the radio signal using the second portion of said transmission resources. In an embodiment, at least a part of the first portion is assigned to the pico base station, too.

In other words, a base station of a macro cell uses a transmission power that is limited to said transmit power limit when transmitting a radio signal using the second portion of the transmission resources so that a pico base station of the pico cell may use the second portion for communicating with terminals registered with the pico base station with low interference. Preferably, the pico base station uses the second portion of transmission resources for communicating with terminals located within an border region of the pico cell, i.e., for communicating with terminals located rather far away from the pico cell base station. Limiting the maximum transmission power of the radio signal transmitted by the macro base stations using the second portion allows not only for reducing an interference between the macro cells and the pico cells embedded therein but also increases a cell size of the pico cell.

The radio resources may be partitioned into the first portion and the second portion according to time. Time may be subdivided into multiple consecutive time units. A first subset of these time units may correspond to the first portion, whereas a second subset of the time units may correspond to the second portion. In a preferred embodiment, the radio transmission resources are partitioned according to frequency, i.e., the first portion corresponds to a first frequency range and/or the second portion corresponds to a second frequency range of the transmission resources.

In LTE, transmission resources are subdivided in the frequency domain into multiple consecutive physical resource blocks (PRB). In time domain, the transmission resources are subdivided into multiple consecutive subframes of a radio frame. Accordingly, when using the method in connection with LTE, the first portion may correspond to a set of one or more physical resource blocks and/or the second portion may correspond to a second set of one or more physical resource blocks, the first and the second set being disjunctive. In an embodiment, the first portion and/or the second portion may correspond to a set of consecutive physical resource blocks. It should be noted that the present invention may be applied in connection with LTE but can also be applied in connection with a cellular communication network of a different type.

In an embodiment, the cellular network has a group of multiple pico base stations and the method comprises assigning the second portion of the transmission resources to all pico base stations of said group. Thus, all pico base stations of that said group may transmit a radio signal within the second portion of the transmission resources. In other words, all pico base stations of the group, preferably all pico base stations of the cellular network, use the identical second portion of the transmission resources in order to communicate with at least one terminal registered with that pico base station.

In an embodiment, the transmit power limit is a predefined static value that can be changed manually only. In another embodiment, the transmit power limit is determined semi-statically or dynamically depending on an operating status of the cellular communication network, preferably the macro base stations, the pico base station, and/or the terminal.

In particular, in a preferred embodiment, the method comprises determining at least one characteristic of communication traffic related to at least one terminal registered with a macro base station and/or the pico base station and determining the transmit power limit depending on said characteristic. Adapting the transmit power limit to the traffic allows for adaptively changing a size, i.e., a coverage area, of the pico cell.

In an embodiment, determining the at least one characteristic comprises retrieving buffer status information of a transmit buffer of a macro base station, a pico base station and/or the terminal. Information about the transmit buffer allows from estimating the amount of data to be transferred between the macro base station or the pico base station and the terminal. For instance, if the terminal is registered with the pico base station and is communicating with the pico base station using the second portion of the transmission resources and if the transmit buffer has many data packets stored to be transmitted over the transmission resources then the transmit power level may be decreased in order to reduce interference between the pico cell and the macro cell in which the pico cell is embedded so that the throughput for the data communication between the pico base station and the terminal can be improved.

Preferably, the method comprises determining the transmit power limit depending on a parameter indicating a density of terminals within a macro cell and/or a pico cell, preferably depending on a number of terminals registered with a certain macro base station or pico base station. For instance, a number of terminals registered with the pico base station can be determined. If the number of terminals registered with the pico base station is low then the transmit power limit may be decreased in the macro base station in order to increase the coverage area of the corresponding pico cell so that additional terminals can register with the pico base station.

In an embodiment, the method comprises assigning the first portion of the transmission resources to the pico cell and limiting the transmission power of a radio signal to be transmitted by the pico base station using the first portion to a pico cell transmit power limit, the pico cell transmit power limit being less than a maximum transmit power of the signal to be transmitted within the pico cell by the pico base station.

Preferably, the method comprises scheduling at least some terminals registered with the pico base station and located at a border region of the pico cell for transmissions using the second portion of the transmission resources and/or scheduling at least some terminals registered with a macro base station and located at the border region of the pico cell for transmissions using the first portion of the transmission resources and/or scheduling at least some terminals registered with a macro base station and located outside of any border region of a pico cell for transmission using the second portion of the transmission resources. Said scheduling may be performed by a scheduler of a macro base station and/or a scheduler of the pico base station.

According to an embodiment, the transmit power limit is determined separately for each macro base station. Determining separate values of the transmit power limit for the individual macro base stations allows for a fine-grained inter-cell interference coordination. In another embodiment, the transmit power limit is determined as a single value for multiple macro base stations. Defining a single value simplifies the implementation of the method.

In an embodiment, the partitioning of the radio transmission resources into the first portion and the second portion is static. In another embodiment, the first portion and/or the second portion is determined depending on said characteristic of the traffic related to at least one terminal and/or said parameter indicating the density of terminals. That is, the first portion and/or the second portion may be determined e.g. semi-statically depending on the operating status of the cellular network.

In an embodiment, the transmission resources comprise multiple channels, each of them occupying a separate frequency band, and wherein the second portion of the radio resources corresponds to one of said multiple channels.

In another embodiment, the transmission resources comprise a single channel subdivided into multiple sub-bands, the first portion and/or the second portion corresponding to a set of sub-bands. Preferably, the first portion and/or the second portion corresponds to a set of multiple consecutive sub-bands. These sub-bands may be arranged consecutively in the frequency domain. In an embodiment, a multi carrier modulation scheme such as orthogonal frequency division modulation (OFDM) is applied. A channel may correspond to a single OFDM carrier. A sub-band may correspond to multiple consecutive subcarriers of the OFDM carrier. In LTE, twelve consecutive subcarriers correspond to a Physical Resource Block (PRB). In an embodiment, a sub-band corresponds to one PRB or multiple consecutive PRBs.

In an embodiment, the method comprises assigning a third portion of said radio transmission resources, preferably a third frequency range of the transmission resources, to at least one macro base station for transmitting the radio signal using the third portion and limiting a maximum transmission power of the radio signal to be transmitted using the third portion to a further transmit power limit being less than a maximum transmit power of the signal to be transmitted using the first portion. The third portion of the radio transmission resources can be used by a neighbouring macro base station for communicating with terminals located at a cell border between neighbouring macro cells. As a consequence, not only interference between the pico cell and the macro cells is coordinated but also interference between a neighbouring macro cells is coordinated. Thus, intra-cell-interference is further reduced and spectral efficiency and/or the overall throughput of the cellular network is further improved.

Another solution of the above mentioned object consists in a network element of a cellular communication network comprising multiple macro base stations controlling at least one of multiple macro cells of the cellular network and at least one pico base station controlling at least one pico cell of the cellular network, said pico cell being located at least partially within at least one macro cell, said network element comprising control circuitry for inter-cell interference coordination arranged for: assigning a first portion of radio transmission resources of the cellular network and a second portion of said transmission resources to each of said multiple macro base stations for transmitting a radio signal using the first portion and the second portion of said transmission resources and limiting a maximum transmission power of the radio signal to be transmitted using the second portion to a transmit power limit being less than a maximum transmit power of the signal to be transmitted using the first portion, wherein said control circuitry is arranged for assigning the second portion of said transmission resources to the pico base station for transmitting the radio signal using the second portion of said transmission resources. This network element as the above-mentioned advantages of the method described above.

Preferably, the control circuitry is arranged for executing a method according to the present invention, embodiments of which are described above. In an embodiment, the control circuitry comprises a processor programmed for executing a method according to the present invention.

In an embodiment, the network element is a macro base station of the cellular network or a pico base station of the cellular network.

A further solution of the above-mentioned object consists in a cellular communication network comprising multiple macro base stations controlling at least one of multiple macro cells of the cellular network and at least one pico base station controlling at least one pico cell of the cellular network, said pico cell being located at least partially within at least one macro cell, said network being arranged for: assigning a first portion of radio transmission resources of the cellular network and a second portion of said transmission resources to each of said multiple macro base stations for transmitting a radio signal using the first portion and the second portion of said transmission resources and limiting a maximum transmission power of the radio signal to be transmitted using the second portion to a transmit power limit being less than a maximum transmit power of the signal to be transmitted using the first portion, wherein the network is arranged for executing a method according to one of claims 1 to 11, embodiments of which are described above.

This cellular communication network has the above-named advantages of the above described method and network element.

### BRIEF DESCRIPTION OF THE FIGURES

Preferred embodiments and further advantages of the present invention are shown in the figures and described in detail hereinafter.

FIG. 1 shows a cellular communication network;

FIG. 2 shows network elements of the cellular network shown in FIG. 1;

FIG. 3 shows diagrams of radio transmission resource allocations;

FIG. 4 shows diagrams of radio transmission resource allocations similar to FIG. 3 according to a different embodiment; and

FIG. 5 shows a further cellular network.

### DESCRIPTION OF THE EMBODIMENTS

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

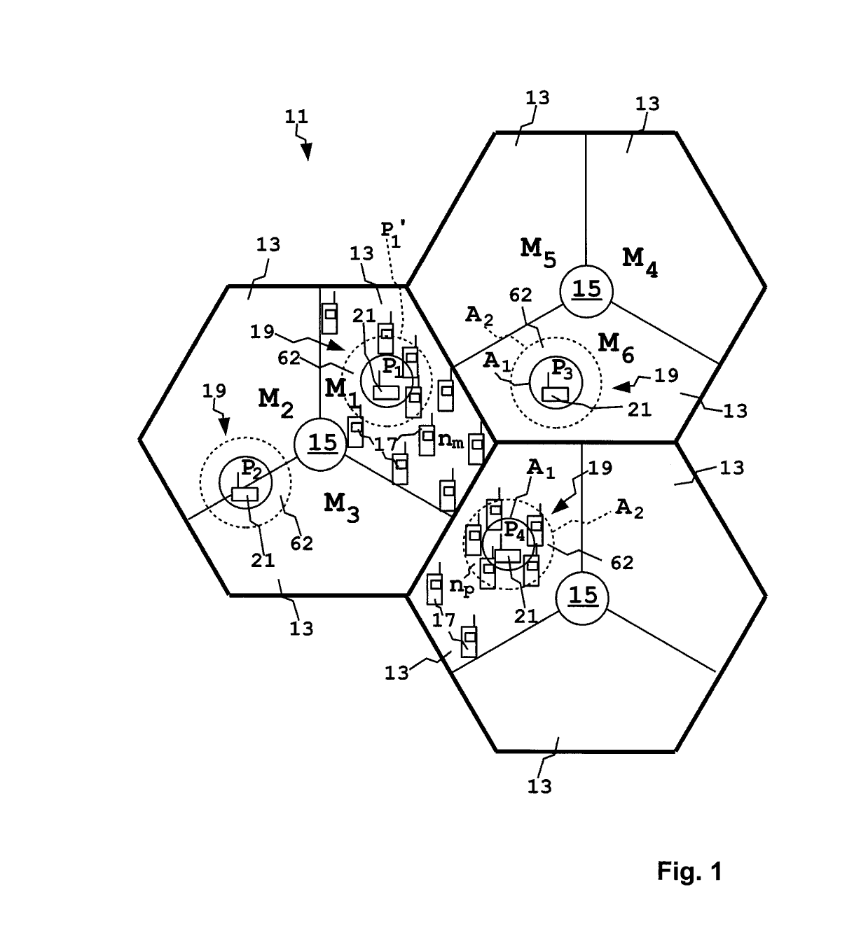

FIG. 1 shows a cellular network 11 having multiple macro cells 13. Each macro cell 13 has a macro base station 15 arranged for controlling the macro cell 13, in particular terminals 17 located within that macro cell 13 and registered with the macro base station 15 of that macro cell 13. In the shown embodiment a single macro base station 15 is assigned to three macro cells 13. In another embodiment, only one macro cell 13 is assigned to a macro base station 15.

Furthermore, the cellular network 11 has multiple pico cells 19, each of them having a pico base station 21. In the shown exemplary embodiment, each pico base station 21 controls exactly one pico cell 19 and terminals 17 registered with the corresponding pico base station 21. A maximum transmission power of a radio signal transmitted by a pico base station 21 is less than a maximum transmission power of a radio signal sent by the macro base station 15. Consequently, the size of a pico cell 19, i.e., the coverage area of a pico cell, is less than the size of a macro cell 13. The pico cells 19 are overlapping with at least one macro cell 13. A pico base station 21 is preferably located within an area where a density of terminals 17 is comparatively high. At least a part of the terminals 17 located within a pico cell 19 may leave the macro cell 13 and register with the pico base station 21 of the pico cell 19. In this way, installing pico base stations 21 in areas with a high density of terminals 17 helps to improve a quality of service and/or a channel capacity experienced by users of the terminal 17 located in that area having a high terminal density.

The cellular network 11 may be part of a Long Term Evolution (LTE) or Long Term Evolution advanced (LTE advanced) mobile communication system. Both LTE and LTE advanced are specified by the Third Generation Partnership project (3GPP). However, the present invention is not limited to LTE or LTE advanced. It may be applied in connection with different types of cellular networks or mobile communication systems, too.

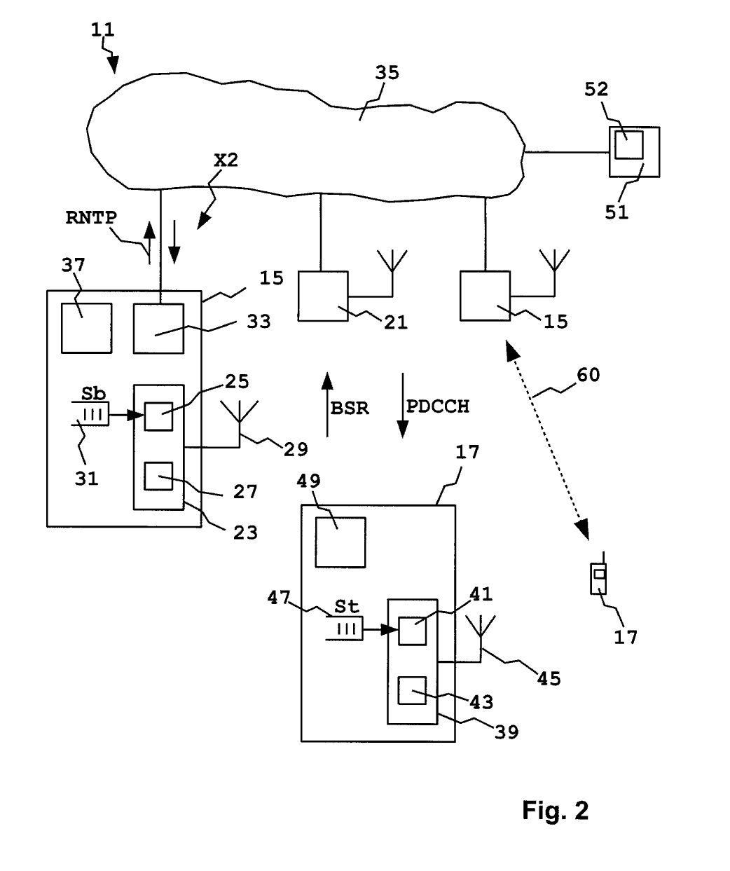

As shown in FIG. 2, each macro base station 15 comprises a first transceiver 23 having a first transmitter 25 and a first receiver 27. The first transmitter 25 and the first receiver 27 are coupled with a first antenna 29 such that the first transmitter 25 can transmit the radio signal to a terminal 17 and the first receiver 27 can receive a radio signal from a terminal 17. The macro base station 15 comprises a first transmit buffer 31 coupled with the first transmitter 25 and arranged for buffering data packets to be transmitted by the first transmitter 25. Moreover, the macro base station 15 has a network interface circuitry 33 that is connected to an interconnection network 35 of the cellular network 11. The interconnection network 35 may be a fixed network or a wireless network. In an embodiment, at least one pico base station 21 is a relay node connected by means of a radio link to a macro base station 15 functioning as a donor base station to which the relay node is assigned.

Furthermore, the macro base station 15 has a first control circuitry 37 arranged for controlling the macro base station 15. The pico base station 21 has essentially the same configuration like the macro base station 15. In particular, the pico base station 21 also comprises the first transceiver 23, the transmit buffer 31, the network interface circuitry 33, and the first control circuitry 37. The first control circuitry 37 may comprise a scheduler for scheduling transmissions between the corresponding base station 15, 21 and the terminals 17 registered with that base station 15, 21. Both the macro base stations 15 as well as the pico base stations 21 are interconnected to each other by means of the interconnection network 35.

Each terminal 17 comprises a second transceiver 39 having a second transmitter 41 and a second receiver 43. The second transmitter 41 is coupled to a second antenna 45 of the terminal 17 for transmitting a radio signal to a base station 15, 21. The second receiver 43 is coupled with the second antenna 45 for receiving a radio signal from a base station 15, 21. The terminal 17 further comprises a second transmit buffer 47 for storing data packets to be transmitted by the second transmitter 41. A second control circuitry 49 of the terminal 17 is arranged for controlling the terminal 17. Both the first control circuitry 37 and the second control circuitry 49 may comprise a processor such as a micro computer, in particular a microcontroller, programmed for controlling the base station 15, 21 or the terminal 17. In particular, the first control circuitry 37 may be arranged or programmed for executing a method for inter-cell interference coordination.

In an embodiment, the network 11 may comprise a central network element 51 connected to the interconnection network 35. The central network element 51 may comprise third control circuitry 52, preferably comprising a processor, arranged and/or programmed for executing a method for inter-cell interference coordination. In another embodiment, the central network element 51 is omitted.

In LTE or LTE advanced, the base station 15, 21 is also referred to as enhanced NodeB (eNodeB). The terminal is also referred to as User Equipment (UE).

In the following, a method for inter-cell interference coordination (ICOIC) is described in more detail. This method not only aims at coordinating the interference between a macro cell 13 and a pico cell 19 that is overlapped by this macro cell 13 but also aims at coordinating the interference between neighbouring macro cells 13.

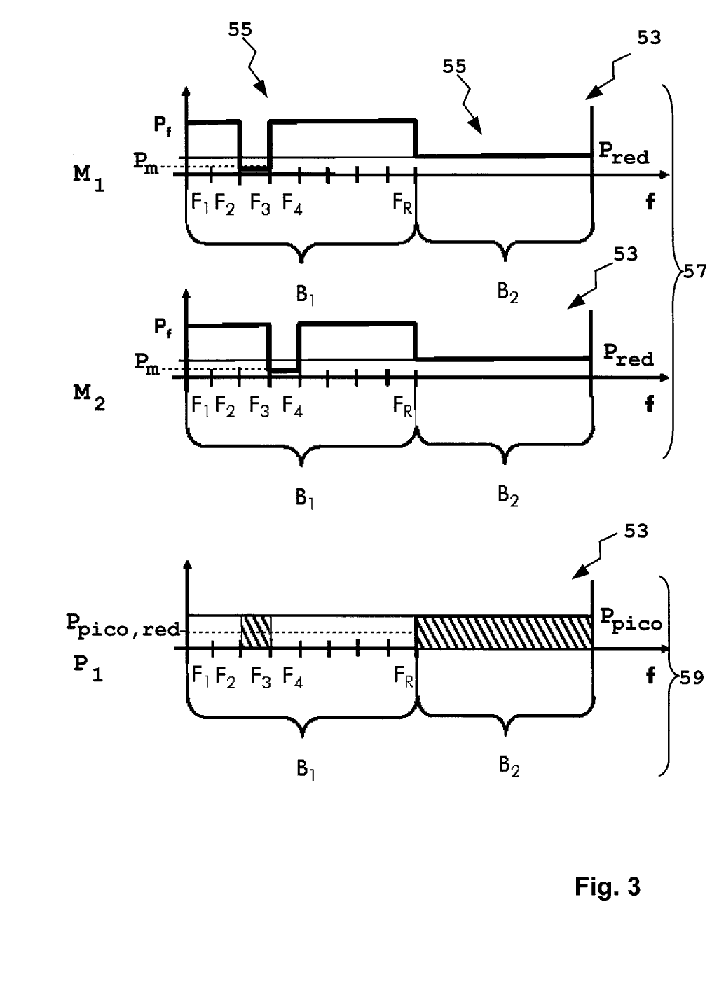

In one embodiment, as shown in FIG. 3, radio transmission resources 53 comprise two channels 55. Each channel 55 occupies a separate frequency band B₁ and B₂. In the shown embodiment, the channels 55 are directly adjacent, i.e., there is no gap between the two frequency bands B₁ and B₂. In another embodiment, the channels 55 are not directly adjacent and there is a gap between the two frequency bands B₁ and B₂. The channels 55 correspond to two portions of the radio transmission resources 53, the first frequency band B₁ corresponding to a first portion of the transmission resources and the second frequency band B₂ corresponding to a second portion of the transmission resources.

According to the method, the transmission resources 53 are assigned to the macro base stations 15 according to a macro cell resource assignment 57 shown in FIG. 3. The first portion of the transmission resource 53, i.e. the first frequency band B₁ is assigned to the macro cells 13. That is, the macro base stations 15 may transmit the radio signal using at least a part of the first frequency band B₁ with a maximum transmit power P_{f}. The second frequency band B₂ is assigned to the macro cells 13, too. However, when using the second frequency band B₂, the macro base stations 15 limit the transmission power of the radio signal to a transmit power limit P_{red}, i.e., the macro base stations 15 transmit with a reduced transmission power. However, the transmission power that can be applied when transmitting using the first frequency band B₁ is not limited to the transmit power limit P_{red}.

According to the method, both frequency bands B₁, B₂ are assigned to the pico cell 19 as shown in a diagram of a pico cell resource assignment 59. In an embodiment, the whole first frequency band B₁ is assigned to the pico cell 19. In another embodiment, only a part of the first frequency band B₁ is assigned to the pica cell 19 (see hedged regions in the diagram of the pico cell resource assignment 59).

Limiting the transmission power of the macro base stations 15 to the transmit power limit P_{red} has the effect that the coverage area of the pica cells 19 increases (so-called “food print increase”). FIG. 1 shows a coverage area A₁ of the pica cells 19 resulting if the macro base stations 15 transmit the radio signal using the second frequency band B₂ with unlimited transmission power. The area A₂ corresponds to the coverage area of the pica cell 19 resulting when the transmission power of the macro base stations 15 is limited to the transmit power limit P_{red} when transmitting using the second frequency band B₂. The coverage area A₁, A₂ correspond to the area in which the terminals 17 can receive control channel data transmitted by the corresponding pico base station 21. In LTE, this control channel may correspond to the Physical Downlink Control Channel (PDCCH), the Physical Broadcast Channel (PBCH), the Physical Control Format Indicator Channel (PCFICH), the Physical Hybrid ARQ Indicator Channel (PHICH), or to another control channel.

In order to coordinate interference between neighbouring macro cells 13 a third portion of the radio transmission resources 53 is assigned to the macro cells 13. When transmitting using the third portion of the transmission resources 53 the macro base stations 15 must limit the transmission power to a further transmit power limit Pₘ that is less than the maximum transmission power P_{f}. In the shown embodiment, the third portion is a sub-band F₁, F₂, . . . , F_{R} of the first frequency band B₁. In general, the first frequency band B₁ is subdivided into R sub-bands F₁, . . . , F_{R}. To each macro cell 13 and the corresponding macro base station 15 a single sub band F₁, . . . , F_{R} is assigned. As a consequence, each macro base station 15 is transmitting within a certain macro cell 13 in an different sub band F₁, . . . , F_{R} with the transmission power limited to the further transmit power limit Pₘ.

Assuming that the cells denoted by M₁ and M₂ are neighbouring macro cells 13, the macro base station 15 of macro cell M₁ can communicate with a terminal 17 which is registered to M1 and located at a cell border between the cells M₁ and M₂ using the sub band F₄ in order to decrease in inter-cell interference between these two macro cells M₁ and M₂. Accordingly, the macro base station 15 of macro cell M₂ can use the sub band F₃ in order to communicate with terminal 17 which is registered to macro cell M₂ and located at the border between the macro cells M₁ and M₂. Partitioning the radio resources 53 into multiple third portions F₁, . . . F_{R} (e.g. subbands F₁, . . . , F_{R}) and assigning to each macro cell 13 of a group of R macro cells 13 a different third portion and configuring or controlling the corresponding macro base stations 15 such that they limit the transmit power within the third portion F₁, . . . , F_{R} assigned to them to the further transmit power limit Pₘ is also referred to as “inverted reuse”. The number of macro cells 13 and the number of different third portions is referred to as a reuse factor R.

In an embodiment, the third portion assigned to a certain macro cell 13 is also assigned to a pico cell 19 that is located within that macro cell 13. The pico base station 21 of that pico cell 19 may use this portion for communicating with terminals 17 located at a region at the edge of the pico cell 19. In the example shown in FIG. 3, the pico cell P₁ is located within the macro cell M₁. Consequently, that pico cell P₁ uses not only the second frequency band B₂, but also the sub band F₃ for communicating with terminals 17 located in a region at the edge of the pico cell 19, i.e., near a border of the coverage area A₂. In order to efficiently assign the transmission resources of the second frequency band B₂ and the sub band F₃, i.e., the third portion assigned to the macro cell 13 in which the pico cell 19 is embedded, cross-carrier scheduling may be used. A control channel (e.g. a PDCCH) of the channel 55 relating to the second frequency band B₂ may signal to the terminals 17 that cross-carrier scheduling is applied.

In an embodiment, a maximum transmission power P_{pico} of the radio signal transmitted by the pico base stations 21 does not vary depending on the frequency band B₁, B₂ or subband F₁, . . . , F_{R} on which the signal is transmitted. In another embodiment, the maximum transmission power P_{pico} depends on the frequency band B₁, B₂ or subband F₁, . . . , F_{R} 55. For instance, the maximum transmission power P_{pico} for the first band B₁ may be limited to a pico cell transmit power limit P_{pico,red} being less than the maximum transmit power P_{pico} for the second band B₂. The pico base station 21 may schedule terminals 17 located near a border of the pico cell 19 preferably on the second band B₂. Moreover, the pico base station 21 may schedule terminals 17 located in an inner region of the pico cell 21 on the first band B₁. Furthermore, a macro base station 15 may schedule terminals 17 registered with a macro cell 13 controlled by this macro base station 15 and located at the border of the pico cell 19 preferably for transmission on the first band B₁.

In the shown embodiment, the value of the transmit power limit P_{red} is adapted depending on the distribution of data traffic relating to the terminals 17 and/or the special density of the terminals 17.

To this end, at least one characteristic of communication traffic 60 related to at least one terminal 17 (i.e. received or transmitted by that terminal 17) may be determined. For example, status information sb of the first transmit buffer 31 of a base station 15, 21 and/or status information st of the second transmit buffer 47 of at least one terminal 17 may be retrieved. The terminal 17 may report the status information st to the base station 15, 21 with which it is registered by transmitting a buffer status report (BSR). The base stations 15, 21 and the central network element 51 may exchange this information sb, st over the interconnection network 35.

Furthermore, according to the method, at least one parameter indicating the density of terminal 17 within a macro cell 13 or a pico cell 19 may be determined. For example, a number nₘ of terminals 17 registered with a macro cell 13 and/or a number nₚ of terminal 17 registered with a pico cell 19 may be determined. The base stations 15, 21 and the central network element 51 may exchange this parameters nₘ, nₚ. After having acquired the characteristics sb, st of the traffic related to the individual terminal 17 and the parameters nₘ, nₚ indicating the density of terminal 17, the method may determine the value of the transmit power limit P_{red} depending on this characteristics sb, st, parameters nₘ, and/or nₚ.

In an embodiment, the partitioning of the transmission resources 53 is adapted depending on the characteristic of the communication traffic related to at least one terminal 17, e.g., depending on the buffer status information sb, st, and/or depending on the spatial distribution of the terminals 17, e.g. on a parameter indicating the density of the terminals such as the number nₘ, nₚ of terminals 17 located in a certain cell 13, 19.

The transmit power limit P_{red} and/or the partitioning of the radio resources 53 between the frequency band B₁ and B₂ may be optimised for maximizing a throughput for fair scheduling or guaranteed bit-rate scheduling in a group of macro cells 13 and pico cells 19 that are affected by inter-cell interference.

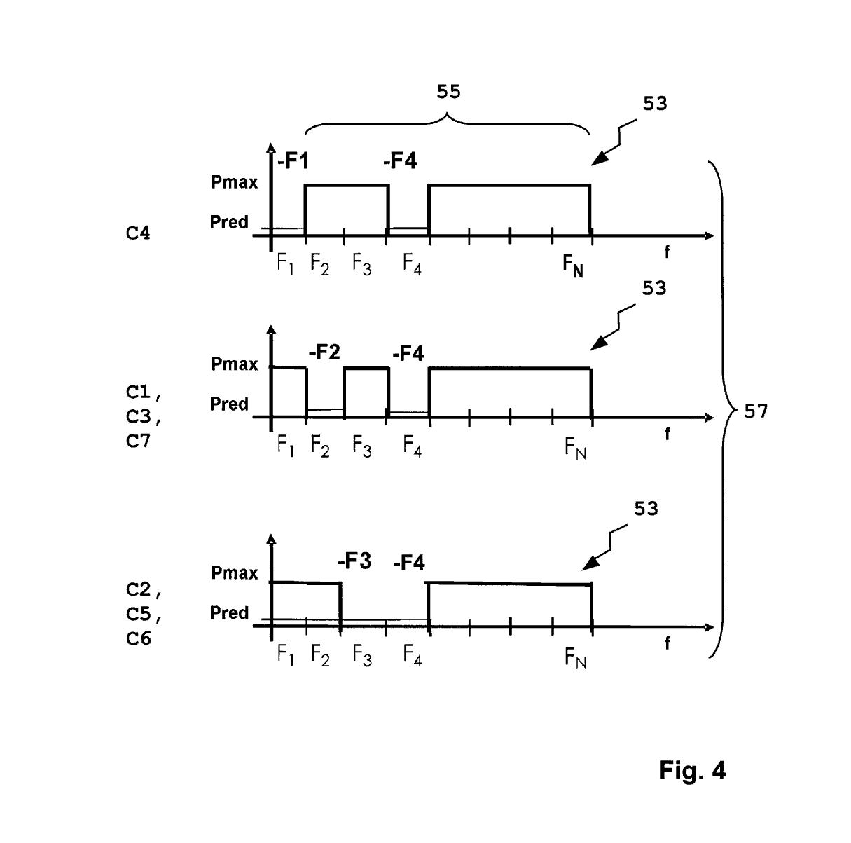

According to another embodiment of the method according to the present invention, the radio resources 53 comprise a single frequency channel 55 only. This channel 55 is subdivided into multiple sub bands F₁, . . . F_{N}. The method provides the macro cell resource assignment 57 as indicated in the two diagrams depicted in FIG. 4, assigning a first portion (all sub bands F₁, . . . , F_{N} except the sub band F₄) to the macro cells 13 and the second portion (the sub band F₄) to the macro cells 13. The macro base stations 15 are allowed to use at least a part of the first portion F₁, . . . , F₃, F₅, . . . , F_{N} for sending a radio signal with the maximum transmission power Pₘₐₓ. However, the macro cell base stations 15 must limit the transmission power of a radio signal transmitted using the second portion F₄ to the transmit power limit P_{red}. Because all macro base stations 15 transmit with the limited transmission power when using the second portion F₄ the pico base stations 21 may use the second portion F₄ for communicating with terminals 17 located nearby a cell border of the corresponding pico cells 19.

Moreover, inverted reuse may be performed. For each macro cell 13 a third portion of the radio resources 53 is allocated and the corresponding macro base stations 15 must limit the transmission power to the further transmit power limit Pₘ when sending a radio signal using the third portion. In the shown embodiment the further transmit power limit is equal to the transmit power limit, P_{red}=Pₘ. In another embodiment these value differ from each other, P_{red}≠Pₘ.

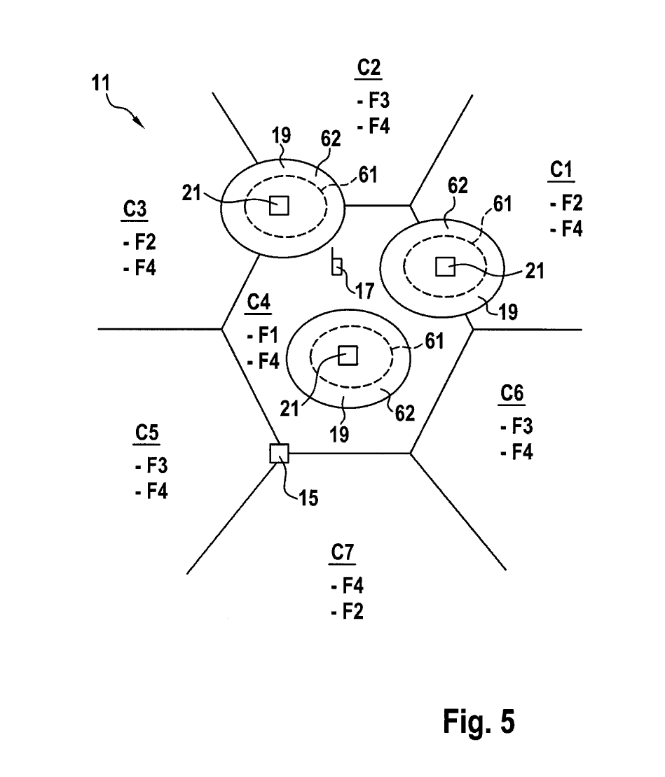

FIG. 4 shows the macro cell resource allocation 57 used for macro cells C₁, . . . , C₇ shown in FIG. 5. In FIG. 4 the second portion F₄ and the third portion F₃ of the transmission resources 53 that may be used with the limited transmission power only by a certain macro base station 15 are depicted. The three different macro cells resource assignments 57 shown in the three diagrams of FIG. 4 are used for the macro cells C₁, . . . , C₇ depicted in FIG. 5. Each macro cell C₁, . . . , C₇ has the same second portion F₄, whereas the third portion (one of F₁, F₂, F₃) of neighbouring macro cells is different in order to reduce inter-cell interference between neighbouring macro cells.

The exemplary cellular network 11 shown in FIG. 5 has three pica cells 19, one of them being completely embedded into the macro cell C₄, another one overlapping with macro cells C₂, C₃, and C₄ and yet another one overlapping with macro cells C₁ and C₄. A terminal 17 may receive signals from different macro cells C₁, . . . , C₇ and/or pica cells. All macro cells C₁, . . . , C₇ and all pica cells 19 have different cell identifiers (cell IDS). Thus, a reference signal in a downlink frame measured by the terminals 17 can be associated to the different cells C₁, . . . , C₇, 19. Signals being transmitted from different base stations 15, 21 can therefore distinguished by each terminal 17.

In an embodiment, the pico base stations 21 use the transmission resources 53 without particular restrictions. For example, in the embodiment shown in FIGS. 4 and 5 the pica base stations 21 may use a maximum transmission power for transmitting the radio signals using all sub bands F₁, . . . F_{N}. However, the maximum transmission power of a pica cell 21 is typically less than the maximum transmission power Pₘₐₓ of the macro cells C₁, . . . , C₇.

In another embodiment, interference measurements are performed and additional restrictions regarding the usage of the transmission resources 53 by the pico base stations 21 are introduced depending on these measurements. The measurements may be carried out by the terminals 17 registered with the pico cells 19 and report it to their serving pico base stations 21. Introducing these additional restrictions further reduces inter-cell interference between the pica cells 19 and the macro cells C₁, . . . C₇ that they overlap. The measurements performed by the terminals may include pathloss measurements and interference measurements.

When deciding on introducing additional restrictions related to the pico cells 19, two exemplary cases can be distinguished.

In a first case, a pico cell 19 is located completely within one macro cell, i.e., that pico cell 19 overlaps only one macro cell. For example, FIG. 5 shows a pico cell 19 that is located completely within the macro cell C₄. Terminal 17 located within that pico cell 19 report measurements to their serving pico base station 21 that indicates that these terminals 19 see the macro cell C₄ as the strongest interfering cell. In addition, the pica base station 21 may determine based on the measurements performed by the terminal whether the terminal 17 is located in an inner region 61 of the pico cell 19 or within a border region 62 of that micro cell 21. According to one embodiment, terminals 21 located in the border region 62 are scheduled on the sub bands F₁ and/or F₄ because these sub bands F₁, F₄ are used with the limited power in the macro cell C₄. In another embodiment, the sub bands F₁ and F₄ are not used at all by the macro cell C₄, i.e., the transmit power limit P_{red} is set to zero. Preferably, the terminal 17 located in the inner region 61 of the pico cell may use all frequency sub-bands F₁, . . . , F_{N}.

Scheduling the terminals 17 located in the border region 62 of the pico cell 19 on the sub-bands F₁ and F₄ induces low interference with the surrounding macro cell C₄. Under ideal circumstances, the interference can be completely avoided.

In a second case, the pico cell 19 is located at a border between multiple macro cells. For example in FIG. 5, there is one pico cell 19 that is located on the border between the macro cells C₁ and C₄. This pica cell 19 overlaps these two macro cells C₁, C₄. Terminals 17 located in the border region 62 of that pico cell 19 are scheduled on sub-band F₄ because the sub-band is used with limited transmit power P_{red} by the macro base stations 15 of macro cells C₁ and C₄. In another embodiment, the transmit power limit P_{red} is zero and the macro cells C₁ and C₄ do not use the sub-band F₄ at all. Terminals 17 located in the inner region 62 of that pico cell 19 may be scheduled on all frequency sub-bands with exception of sub-bands F₁ and F₂ which are used by the macro cells C₁ and C₄ for communicating with terminal 17 located on the border between them.

In another embodiment, the terminals located in a border region 61 of a pico cell 19 are scheduled on those sub-bands that belong to the third portion of sub-bands of the macro cells that are overlapped by the pica cell 19. Moreover, the pico base station 21 may schedule terminals 17 located in the border region 62 of the corresponding pico cell 19 and within a certain macro cell on the sub-band that belongs to the third portion of that macro cell. For example, a terminal 17 located in the border region 62 of the pica cell 19 on the right hand side of FIG. 5 and within the macro cell C₁ may be scheduled by the pico base station 21 of that pica cell on the sub-band F₂ which corresponds to the third portion of radio resources 53 assigned to that macro cell C₁.

If that terminal 17 moves to the macro cell C₄ without leaving the border region 62 of the pica cell 19 (and staying registered with the pico station 21) then the pico base station 21 may schedule the terminal 17 on sub-band F₁ because the sub-band F₁ corresponds to the third portion of radio resources 53 assigned to the macro cell C₄. Furthermore, the pico base station 21 may schedule the terminal 17 on the sub-band F₄ because all macro base stations 15 use this sub-band corresponding to the second portion of the radio resources 53 with the transmit power limited to the transmit power limit P_{red}.

The restrictions and limits regarding the transmit power of the sub-bands F₁, . . . , F_{N} may be configured statically or semi-statically. In an embodiment according to which these restriction and limits are configured statically, the first portion of radio transmission resources of the cellular network and the second portion of said transmission resources are assigned statically to each of the multiple macro base stations for transmitting a radio signal using the first portion and the second portion of the transmission resources. Each of the multiple macro base stations is arranged for limiting a maximum transmission power of the radio signal to be transmitted using the second portion to the transmit power limit P_{red} less than the maximum transmit power P_{f} of the signal to be transmitted using the first portion.

In an embodiment, the above-described method is executed by a network element of the cellular network 11, such as a base station 15, 21 or the central network element 51. The method may be executed by one of these network elements 15, 21, 51 or distributed on multiple network elements 15, 21, 51. In both cases, information about resource assignments 57, 59 may be exchanged between the network elements 15, 21, 51 over the interconnection network 35. To this end, the X₂ interface of LTE may be applied, which allows for information exchange between different base stations 15, 21. In particular, the base stations 15, 21 and the central network element 51 may exchange Relative Narrowband Transmit Power (RNTP) messages that indicate physical resource blocks (PRB) that are guaranteed to have a power allocation below a power threshold, e.g., the transmit power limit P_{red} or the further transmit power limit Pₘ.

To sum up, the method described above allows for reducing interference between a pico cell 19 overlapping one or more macro cells 13 by reserving a portion of the transmission resources 53 that may be used by the pico base stations 21 to communicate with terminals 17 located within the border region 61 of the corresponding pico cells 19. The macro base stations 15 transmit on this portion of the radio transmission resources 53 with a transmission power limited to the transmission power limit P_{red}. Alternatively, the macro base stations 15 do not transmit on this portion of the radio transmission resources 53 not at all. Furthermore, a inverted reuse scheme is used for coordinating interference between neighbouring macro cells and for further reducing the interference between the pico cells 29 and/or macro cells 13. Moreover, the method allows for increasing the size of a pico cell 19 without increasing a maximum transmit power of this pico cell 19.

1. Method for inter-cell interference coordination in a cellular communication network comprising multiple macro base stations controlling at least one of multiple macro cells of the cellular network and at least one pico base station controlling at least one pico cell of the cellular network, said pico cell being located at least partially within at least one macro cell, said method comprising
assigning a first portion of radio transmission resources of the cellular network and a second portion of said transmission resources to each of said multiple macro base stations for transmitting a radio signal using the first portion and the second portion of said transmission resources and
limiting a transmission power of the radio signal to be transmitted using the second portion to a transmit power limit being less than a maximum transmit power of the signal to be transmitted using the first portion,
wherein the method further comprises
assigning the second portion of said transmission resources to the pico base station for transmitting the radio signal using the second portion of said transmission resources.

2. Method according to claim 1, wherein the first portion corresponds to a first frequency range and/or the second portion corresponds to a second frequency range of the transmission resources.

3. Method according to claim 1, wherein the cellular network has a group of multiple pico base stations and the method comprises assigning the second portion of the transmission resources to all pico base stations of said group.

4. Method according to claim 1, wherein the method comprises determining at least one characteristic of communication traffic related to at least one terminal registered with a macro base station and/or the pico base station and determining the transmit power limit depending on said characteristic.

5. Method according to claim 4, wherein determining the at least one characteristic comprises retrieving buffer status information of a transmit buffer of a macro base station, a pico base station and/or the terminal.

6. Method according to claim 1, wherein the method comprises determining the transmit power limit depending on a parameter indicating a density of terminals within a macro cell and/or a pico cell, preferably depending on a number of terminals registered with a certain macro base station or pico base station.

7. Method according to claim 1, wherein the method comprises assigning the first portion of the transmission resources to the pico cell and limiting the transmission power of a radio signal to be transmitted by the pico base station using the first portion to a pico cell transmit power limit, the pico cell transmit power limit being less than a maximum transmit power of the signal to be transmitted within the pico cell by the pico base station.

8. Method according to claim 1, wherein the method comprises scheduling at least some terminals registered with the pico base station and located at a border region of the pico cell for transmissions using the second portion of the transmission resources and/or scheduling at least some terminals registered with a macro base station and located at the border region of the pico cell for transmissions using the first portion of the transmission resources and/or scheduling at least some terminals registered with a macro base station and located outside of any border region of a pico cell for transmission using the second portion of the transmission resources.

9. Method according to claim 1, wherein the first portion and/or the second portion is determined depending on said characteristic of the traffic related to at least one terminal and/or said parameter indicating the density of terminals.

10. Method according to claim 2, wherein the transmission resources comprise multiple channels, each of them occupying a separate frequency band, and wherein the second portion of the radio resources corresponds to one channel of said multiple channels.

11. Method according to claim 1, wherein the method comprises assigning a third portion of said radio transmission resources, preferably a third frequency range of the transmission resources, to at least one macro base station for transmitting the radio signal using the third portion and limiting a maximum transmission power of the radio signal to be transmitted using the third portion to a further transmit power limit being less than a maximum transmit power of the signal to be transmitted using the first portion.

12. Network element of a cellular communication network comprising multiple macro base stations controlling at least one of multiple macro cells of the cellular network and at least one pico base station controlling at least one pico cell of the cellular network, said pico cell being located at least partially within at least one macro cell, said network element comprising control circuitry for inter-cell interference coordination arranged for
assigning a first portion of radio transmission resources of the cellular network and a second portion of said transmission resources to each of said multiple macro base stations for transmitting a radio signal using the first portion and the second portion of said transmission resources and
limiting a maximum transmission power of the radio signal to be transmitted using the second portion to a transmit power limit being less than a maximum transmit power of the signal to be transmitted using the first portion,
wherein said control circuitry is arranged for
assigning the second portion of said transmission resources to the pico base station for transmitting the radio signal using the second portion of said transmission resources.

13. Network element according to claim 12, wherein the control circuitry is arranged for executing a method for inter-cell interference coordination in the cellular communication network.

14. Network element according to claim 12, wherein the network element is a macro base station of the cellular network or a pico base station of the cellular network.

15. Cellular communication network comprising multiple macro base stations controlling at least one of multiple macro cells of the cellular network and at least one pico base station controlling at least one pico cell of the cellular network, said pico cell being located at least partially within at least one macro cell, said network being arranged for
assigning a first portion of radio transmission resources of the cellular network and a second portion of said transmission resources to each of said multiple macro base stations for transmitting a radio signal using the first portion and the second portion of said transmission resources and
limiting a maximum transmission power of the radio signal to be transmitted using the second portion to a transmit power limit being less than a maximum transmit power of the signal to be transmitted using the first portion,
wherein the network is arranged for executing a method according to claim 1.
